(19) United States
(12) Patent Application Publication
(10) Pub. No.: US 2004/0132464 A1
(43) Pub. Date: Jul. 8, 2004

(54) Location system

(76) Inventors: Sami Poykko, Espoo (FI); Jani Moilanen, Helsinki (FI); Veli-Matti Teittinen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/664,071

(22) Filed: Sep. 17, 2003

Related U.S. Application Data
(60) Provisional application No. 60/434,649, filed on Dec. 20, 2002.

(51) Int. Cl. H04Q 7/20

(52) U.S. Cl. 455/456.1; 455/404.2

(57) ABSTRACT

A method of providing information regarding a location of a mobile user of a communication system is provided. The method comprises a step of performing measurement for provision of input data for a location calculation function. The method includes a step of analyzing the measurements to identify suspicious measurements. The method also comprises a step of deciding selected measurements for use by the location calculation function. The method also includes a step of calculating a location estimate for a mobile user based on the selected measurements.

### CROSS-REFERENCE TO RELATED APPLICATIONS

This application claims priority of Provisional Application Serial No. 60/434,649 entitled “Improvements in a Location System,” filed Dec. 20, 2002, the entire contents of which are incorporated herein by reference.

### BACKGROUND OF THE INVENTION

1. Field of the Invention

The present invention relates to a location information provision system, and in particular, to provision of location information by means of elements associated with a communication system such as a cellular communication system or other communication system providing mobility for the users thereof.

2. Description of the Related Art

A cellular telecommunications system is a communication system that is based on use of radio access entities and/or wireless service areas. The access entities are typically referred to as cells. Examples of cellular telecommunications systems include standards such as the GSM (Global System for Mobile communications) or various GSM based systems (such as GPRS: General Packet Radio Service), AMPS (American Mobile Phone System), DAMPS (Digital AMPS), WCDMA (Wideband Code Division Multiple Access), TDMA/CDMA (Time Division Multiple Access/Code Division Multiple Access) in UMTS (Universal Mobile Telecommunications System), CDMA 2000, i-Phone and so on.

In a cellular system, a base transceiver station (BTS) provides a wireless communication facility that serves mobile stations (MS) or similar wireless user equipment (UE) via an air or radio interface within the coverage area of the cell. As the approximate size and the shape of the cell is known, it is possible to associate the cell to a geographical area. Each of the cells can be controlled by an appropriate controller apparatus.

Elements of the cellular network can be employed for provision of location information concerning a mobile station and the user thereof. More particularly, the cells or similar geographically limited service areas facilitate the cellular telecommunications system to produce at least a rough location information estimate concerning the current geographical location of a mobile station, as the cellular telecommunications system is aware of the cell with which a mobile station currently associates. Therefore it is possible to conclude from the location of the cell the geographical area in which the mobile station is likely to be at a given moment. This information is available also when the mobile station is located within the coverage area of a visited or “foreign” network. The visited network may be capable of transmitting location information of the mobile station back to the home network, e.g. to support location services or for the purposes of call routing and charging.

A location service feature may be provided by a separate network element such as a location server which receives location information from at least one of the controllers of the system. If no further computations and/or approximations are made, this provides the location to an accuracy of one cell. In other words, this calculation indicates that the mobile station is (or at least was) within the coverage area of a certain cell.

However, more accurate information concerning the geographical location of a mobile station may be desired. For example, the United States Federal Communication Commission (FCC) has mandated that wireless service providers provide location technologies that can locate wireless phone users who are calling to emergency numbers. Although the FCC order is directed to emergency caller location, other (commercial and non-commercial) uses for mobile systems, such as fleet management, location-dependent billing, advertising and information provision or navigation applications, may also find more accurate location information useful. As an example of the estimated value of the locations service a reference can be made to a research report by the “Strategis Group” which claims that location-based services would create over 16 billion in U.S. dollars annual worldwide revenue by year 2005.

The accuracy of the location determination may be improved by utilizing results of measurements which define the travel time (or travel time differences) of the radio signal sent by a mobile station to the base station. More accurate location information may be obtained through e.g. by calculating the geographical location from range or range difference (RD) measurements. All methods that use range difference (RD) measurements may also be called TDOA (time difference of arrival) methods (mathematically RD=c*TDOA, wherein c is the signal propagation speed). Observed time difference (OTD), E-OTD (Enhanced OTD) and TOA (time of arrival) are mentioned herein as examples of technologies that are based on the RD measurements.

The difference between the TOA (time of arrival) and the E-OTD is in that in the TOA the mobile station sends the signal and the network takes the measurements, whereas in the E-OTD the network sends the signals and the mobile station measures them. The mobile stations are provided with appropriate equipment and software capable of providing information on which the positioning of the mobile station can be determined. The mobile station may communicate the information via the base to an appropriate network element that may use the information in a predefined manner.

It is also possible to form RD measurements based on other sources, e.g. from GPS (Global Positioning System) pseudo-range measurements.

The measurements are accomplished by a number of base stations (preferably at least three) covering the area in which the mobile station is currently located. The measurement by each of the base stations gives the distance (range) between the base station and the mobile station or the distance difference (range difference) between the mobile station and two base stations. Each of the range measurements generates a circle that is centered at the measuring base station, and the mobile station is determined to be located at an intersection of the circles. Each of the range difference measurement by the two base stations creates a hyperbola (not a circle as in the range measurements). Thus if range differences are used in the location calculation, the intersections of the hyperbolas are determined. In an ideal case and in the absence of any measurement error, the intersection of the circles or the hyperbolas may unambiguously determine the location of the mobile station.

In principle, in the hyperbolic case two hyperbolas (i.e., measurements from three different sites), and in the circular case two circles (i.e., measurements from two different sites) are enough for location estimation. However, circles/hyperbolas can intersect twice, which means that in an ideal case, measurement from one more site is needed for an unambiguous solution unless some prior information is available which is good enough to reject the wrong solution.

The measurements are only rarely accomplished in ideal conditions and will practically always include some degree of error. The error may be caused e.g. by a blocking in the direct radio propagation path between the transmitting and receiving stations. This non-line of sight (NLOS) phenomenon is known to be one of the major sources of error in position location because it causes the mobile station to appear further away from the base station than it actually is. For example, in a dense urban environment several obstacles may cause the mobile station to repeatedly and/or continuously lose the direct line of sight with one or several of the base stations. The NLOS causes an increased path length the radio signal has to travel between the transmitting station and the receiving station in order to circumvent all the obstructing elements. Reflections and/or diffraction may also cause error. Thus the first arriving wave may travel excess path lengths on the order of hundreds of meters if the direct path is blocked. Incorrect location information may also be caused by multipath propagation, synchronization errors, measurement errors, errors in RTT (Round Trip Time) determination and so on. Therefore, if three or more circles/hyperbolas are used for the location estimation, the circles or hyperbolas may not intersect in a same point due to the measurement error. It is also possible that the circles/hyperbolas do not intersect at all because of measurement errors.

The realization of location-based services for commercial and emergency service relies on the assumption that cost effective and reliable methods for cellular location will become available. A problem in the present cellular location methods is the accuracy of the location that can be achieved by the present methods. The common method for estimating the location accuracy for a location method provides error limits within the range of 67% and 95% of the cases.

The Enhanced Observed Time Difference (E-OTD) location method has been selected by various operators as the location method for fulfilling the Federal Communications Commission (FCC) E911 phase II requirements. The FCC emergency number 911 (E911) Phase II requires that the location error for Automatic Location Identification (ALI) purposes for E-OTD capable mobile station handsets has to be less than 100 meters in 67% of the cases and less than 300 meters for 95% of the cases.

Therefore there is a need to improve the accuracy of location calculations that are based on location measurement data produced by means of mobile telecommunication equipment.

### SUMMARY OF THE INVENTION

Embodiments of the present invention aim to address one or several of the above problems.

According to one aspect, a method of providing information regarding the location of a mobile user of a communication system is provided. The method comprises performing measurements for provision of input data for a location calculation function, analyzing the measurements to identify suspicious measurements, deciding which measurements are selected for use by the location calculation function, and calculating a location estimate for the mobile user based on the selected measurements.

The effect of the suspicious measurements can be reduced or even removed by means of the selection data. The reduction of the influence by suspicious measurements may be implemented by fully rejecting the suspicious measurement results or by reducing the weight of the suspicious measurement results in the location calculations.

A location system comprises a controller configured to control at least one base station. A location service node is configured to provide a client application with a measurement regarding the geographic location information of at least one mobile station. An interface is configured to receive the measurement regarding the geographic location information of the at least one mobile station and to transmit the measurement regarding the geographic location information to a location device. The location device is configured to determine a location estimate based upon the measurement regarding the geographic location. A suspicious measurement identifier is configured to identify suspicious measurements by analyzing a discrepancy between the measurement and the location estimate.

A method for providing location information to a user in a communication system. The method comprises controlling at least one base station, providing a client application with a measurement regarding the geographic location information of at least one mobile station, receiving the measurement of the geographic location information of the at least one mobile station, transmitting the measurement of the geographic location information to a location means for providing location services, determining a location estimate based upon the measurement of the geographic location, and identifying suspicious measurements by analyzing a discrepancy between the measurement and the location estimate.

A location system comprises controlling means for controlling at least one base stations, a first providing means for providing a client application with a measurement regarding geographic location information of at least one mobile station, receiving means for receiving the measurement regarding the geographic location information of the at least one mobile station, transmitting means for transmitting the geographic location information to a location means for location services, determining means for determining a location estimate based upon the measurement of the geographic location, and identifying means for identifying suspicious measurements by analyzing a discrepancy between the measurement and the location estimate.

The embodiments of the invention may improve the accuracy of the location determination.

### BRIEF DESCRIPTION OF THE DRAWINGS

For better understanding of the present invention, reference will now be made by way of example to the accompanying drawings in which:

FIG. 1 shows an environment wherein the invention can be embodied;

FIG. 2 is a flowchart illustrating the operation in accordance with an embodiment of the invention; and

FIG. 3 is a flowchart illustrating the operation of an embodiment of the invention; and

FIG. 4 is a flowchart illustrating the operation of an embodiment of the invention.

### DETAILED DESCRIPTION OF PREFERRED EMBODIMENTS

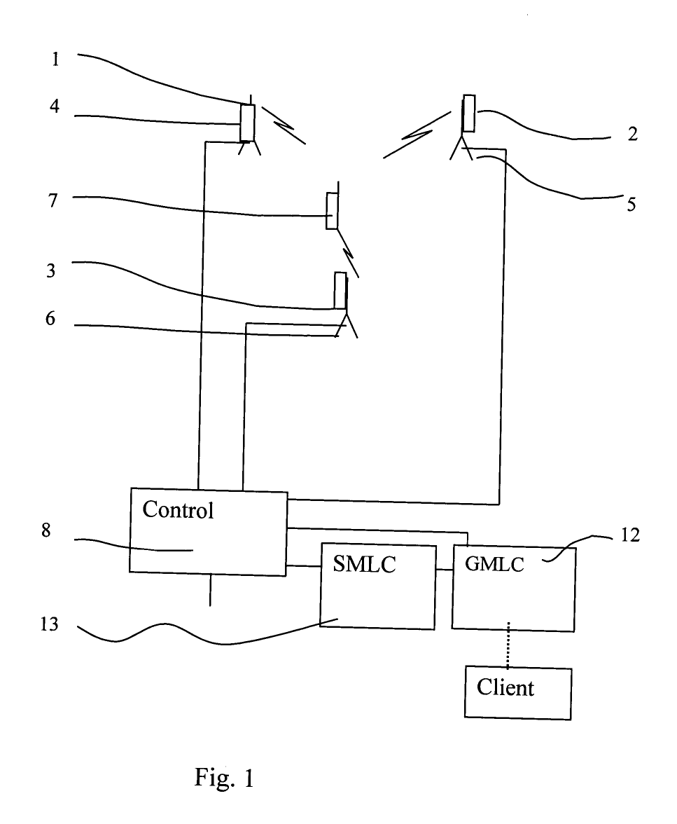

Before explaining the preferred embodiments of the invention in more detail, a reference is made to FIG. 1 which is a simplified presentation of some of the components of a cellular system. More particularly, FIG. 1 shows an arrangement in which three base stations 4, 5 and 6 provide three radio coverage areas or cells of a cellular telecommunications network.

Each base station 4 to 6 is arranged to transmit signals to and receive signals from the mobile user equipment (UE) i.e. mobile station (MS) 7 via a wireless communication. Likewise, the mobile station 7 is able to transmit signals to and receive signals from the base stations. It shall be appreciated that a number of mobile stations may be in communication with each base station although only one mobile station 7 is shown in FIG. 1 for clarity.

The cellular systems provide mobility for the users thereof. In other words, the mobile station 7 is able to move from one cell coverage area to another cell coverage area. The location of the mobile station 7 may thus vary in time as the mobile station is free to move from one location (base station coverage area or cell) to another location (to another cell) and also within one cell.

It shall be appreciated that the presentation is highly schematic and that in practical implementations the number of base stations may be substantially higher. One cell may include more than one base station site. A base station apparatus or site may also provide more than one cell. These features of a cell depend on the implementation and circumstances.

Each of the base stations 4 to 6 is controlled by appropriate controller function 8. The controller function may be provided by any appropriate controller. A controller may be provided in each base station or a controller can control a plurality of base stations. Solutions wherein controllers are provided both in individual base stations and in the radio access network level for controlling a plurality of base stations are also known. It shall thus be appreciated that the name, location and number of controller entities depend on the system. For example, a UMTS terrestrial radio access network (UTRAN) may employ a controller node that is referred to as a radio network controller (RNC). In the GSM a corresponding radio network controller entity is referred to a base station controller (BSC).

The core network of both of the above mentioned systems may be provided with controller entities referred to as a mobile switching center (MSC). It is also noted that typically more than one controller is provided in a cellular network.

In this specification all such possible controllers are denoted by the controller element 8 of FIG. 1. The controller 8 may be connected to other appropriate elements, such as to another mobile switching center (MSC) and/or a serving general packet radio service support node (SGSN), via a suitable interface arrangement. However, as these do not form an essential part of the invention, the various other possible controllers are omitted from FIG. 1 for clarity reasons.

The communication system is also shown to include a device for providing a location service. More particularly, FIG. 1 shows a location services (LCS) node 12 for providing location services for different applications or clients. In general terms, a location services node can be defined as an entity capable of providing client applications with information concerning the geographical location of a mobile station. There are different ways to implement the location services node, and the following will discuss an example that employs the so called gateway mobile location center (GMLC).

The gateway mobile location center (GMLC) 12 is configured to receive via appropriate interface means predefined information concerning the geographical location of the mobile station 7 from the cellular system. In addition to the information associated with the geographical location the information provided for the node 12 may include an identity (such as an international mobile subscriber identifier: IMSI) or a MSIDSN (a mobile subscriber integrated digital services number) or a temporary identifier of the mobile station 7.

The location information may be provided for the GLMC 12 by a serving mobile location center (SMLC) 13. The serving location service center node 13 can be seen as an entity that functions to process location measurement data received from the network in order to determine the geographical location of the mobile station. The Location measurement data may be provided by various elements associated with the network such as means of one or several location measurement units 1 to 3 provided in association with at least some of the base stations and/or the mobile station 7. The serving location service node 13 is configured to process this measurement data and/or some other predefined parameters. The serving location service node 13 is also configured to input information and/or to execute appropriate calculations for determining and outputting information associated with the geographical location of the given mobile station 7. The output information will be referenced below as location estimate.

In other words, the information from the various location measurement means is processed in a predefined manner by the serving location service node 13. A location estimate may then be provided to the GMLC 12. Authorized clients are then served by the GMLC 12.

The serving location service node 13 may be implemented in the radio access network or the core network. If the serving location service node 13 is implemented in the radio access network it may be in direct communication with the access network controller function 8 and the LCS node 12. In some applications the servicing location service node 13 may be a part of the access network controller function. If the serving location service node 13 is implemented in the core network it may then be arranged to receive the location measurement data from the radio network e.g. via the access network control function 8. The manner in which the location service architecture is configured is an implementation issue, and will thus not be explained in more detail.

As mentioned above, the location information may be provided as a location estimate. The location estimate may be defined on the basis of the measurements regarding the position of the mobile station relative to the base station(s). This information may be produced by specific location measurement units 1 to 3 or similar implemented on the network side and/or by the mobile station itself.

The geographical location of a mobile station may be defined, for example, in geographical co-ordinates (latitudes and longitudes) or in X and Y co-ordinates. Another alternative is to use the relation between defined radii and angles, e.g. based on the spherical coordinate system. According to another embodiment, the invention may define the location of a mobile station according to vertical directions. For example, altitude or Z co-ordinate may be used when providing the location information in the vertical direction. The vertical location may be needed e.g. in mountainous environments or in tall buildings.

The basic measurement data for the location service may be obtained by using one or more of the appropriate location determination techniques. Various examples of these are known and all possibilities will thus not be discussed in any great detail herein. Examples of the possible location determination methods include techniques that are based on use of the E-OTD (enhanced Observed time difference), time of arrival (ToA), time difference of arrival (TDoA), the signal Round Trip Time (RTT), and timing advance (TA) information, signal strength measurements, and so on. The geographical location information may also be based on use of information provided by a location information services system that is independent from the communication system. Examples of these include the Global Positioning System (GPS), Assisted GPS (A-GPS) or the Differential GPS (D-GPS).

As discussed above, the location measurement data originating from various sources may be erroneous. Therefore the estimate provided by the computing functions at the SMLC 13 may not always be accurate enough.

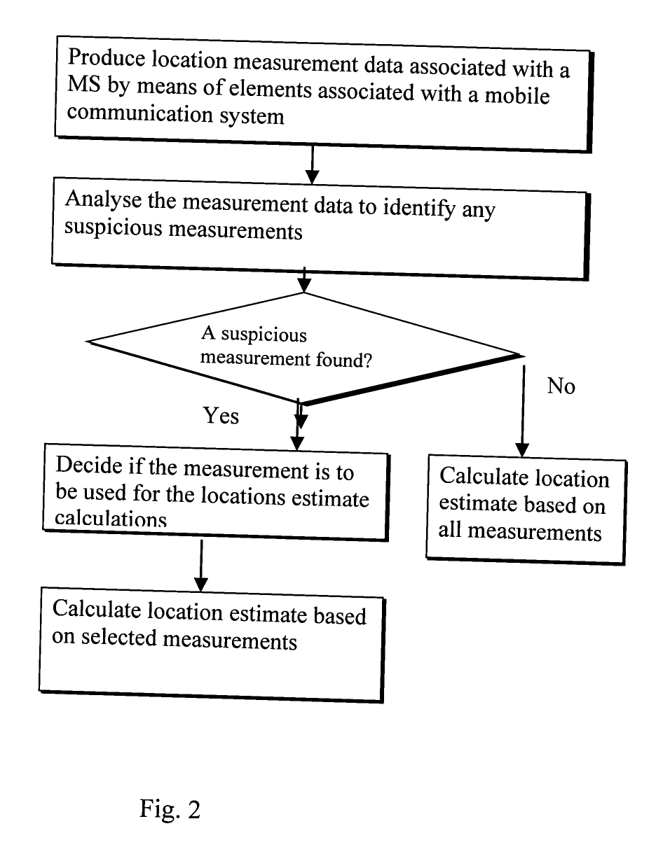

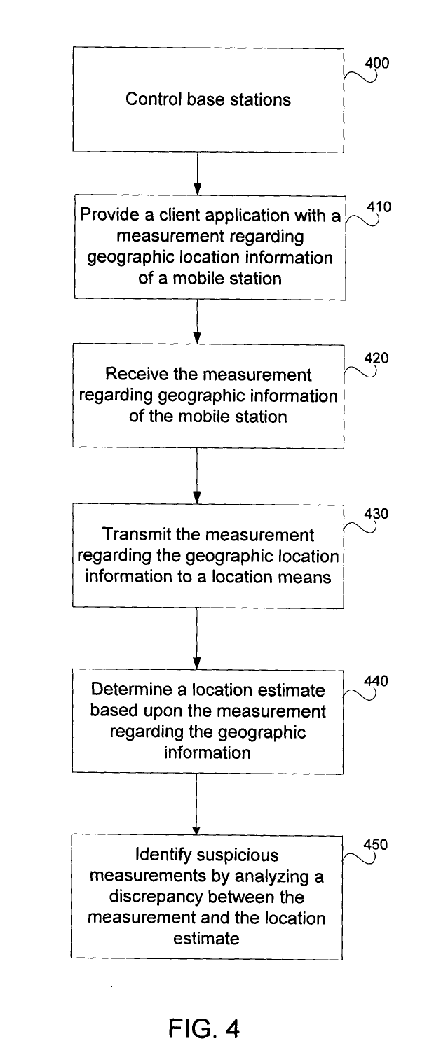

The invention improves the accuracy of the location calculations by identifying suspicious measurement results before the final calculations of the location estimate. This concept is illustrated, for example, in the flowcharts of FIG. 2 and FIG. 4.

The effect of the suspicious measurements can be reduced or even removed based on a process for selecting data to be input in0to the location estimate calculations. The reduction of the influence by suspicious measurements may be done by fully rejecting the suspicious measurement results or by reducing the weight of the suspicious measurement results in the location calculations.

Suspicious measurements are preferably identified by analyzing the discrepancy between the measurements and the obtained location estimate. The identified suspicious measurements will be referenced to in the following as bad measurements.

The location calculation unit, such as the Serving Mobile Location Center (SMLC) 13 may be used to remove one at time the measurements and calculate a location estimate and associated confidence area with the remaining measurements. The confidence area shall be understood as an area which is estimated to include the real location of the mobile station within certain confidence level. It is possible to calculate different discrepancy values for each location estimate and confidence area either with removed measurements or without any removed measurements.

The discrepancy value will be referenced to in the following as discrepancy gauge. The discrepancy gauge can be defined as a quantity that indicates how much a set of measurement has discrepancies with the obtained location estimate. A discrepancy gauge can be expressed as any quantity derived from the measurements and location estimate obtained using the measurements. A discrepancy gauge gives an estimate for the quantity of discrepancy between the measurements and obtained location estimate.

In the following a generic description of a possible discrepancy gauge will be described in the context of the E-OTD location method. In the E-OTD location method the mobile station (MS) 7 measures the Observed Time Difference (OTD) between the arrivals of bursts from the serving base station and neighbor base stations. The OTD value consists of two components:

OTD=RTD+GTD Equation [1]

In equation [1] the RTD (Real Time Difference) is the synchronization difference between the base stations. It describes how much earlier or later a base station transmits in comparison to another base station. If the network is synchronized, the RTDs should be zero. The GTD (Geometric Time Difference) is the component that is due to different propagation times (i.e. distances) between the mobile station MS and the two base stations. This is the actual quantity that includes information about the location:

GTD=[d(MS,BTS2)−d(MS,BTS1)]/c Equation [2]

where

d(MS,BTSx) is the distance between the MS and BTS x, and

c is the speed of light.

The above equation [2] determines a hyperbola, which is the curve of possible locations for a mobile station MS observing a constant GTD value between the base stations at known positions. When there are at least two such hyperbolas available (i.e. one serving and two neighboring BTS sites are used for the measurements), the location estimate can be found at the intersection of the hyperbolas. If more E-OTD values are available, the location area of the mobile station 7 can be deduced more accurately.

In practice, however, the hyperbolas do not cross at single and well-defined point. Instead there is a set of crossing points. Therefore, a certain amount of discrepancy between the measurements and the resulting location estimate exists.

In such a situation a discrepancy gauge may be set such that it reaches its minimum value if all hyperbolas obtained by means of E-OTD cross at a single point. In this situation all measured Geometric Time Difference (GTD) values may be in perfect agreement with the obtained location estimate.

To clarify the basic concept of the invention, in a situation where the location measurements have resulted in three perfect measurements with no errors and crossing each other in single point, and a fourth measurement with an error, the hyperbola with error does not cross the others at the same point.

In this embodiment, the resulting location estimates without and with the fourth hyperbola. If the measurement with the measurement error is ignored, the location estimate may be at the crossing point. All three hyperbolas used in the calculation may be in perfect agreement with the obtained location estimate. The discrepancy gauge may reach its minimum value. However, if the fourth measurement is used, the location estimate is generally not exactly at the crossing point of the three other hyperbolas. Now all measurements may have certain amount of discrepancy with the location estimate, also the ones with no errors. The discrepancy gauge is now hence larger than in the case wherein the erroneous measurement was ignored. Thus there is a clear indication that there is discrepancy between the measurements and the resulting location estimate.

Similarly, if any measurement other than the one with measurement error is rejected, the resulting location estimate may not be perfectly in line with the measurements, and the obtained discrepancy gauge may be larger than its minimum value. In other words, the minimum value of discrepancy gauge may be obtained only if the measurement with the largest error is rejected.

As explained above, in real-life all locations measurements have a certain amount of measurement and other errors associated with them. According to the invention, it is noted that if the measurement with the largest error or even all suspicious measurements are ignored, the value of the discrepancy gauge will decrease. Therefore use of discrepancy gauges can be used the to detect the presence of large errors in the measurements. After the large errors in measurements are detected, their effect to the location estimate and to the associated confidence region can be reduced.

The following examples provide three exemplifying ways to provide discrepancy gauges for use in detection of bad measurements in the E-OTD location applications. It shall be appreciated that these examples are given only to clarify the invention without any intention to limit the scope thereof by these specific examples. As mentioned above, there are numerous ways to produce a location estimate based on various types of measurement data, and therefore the is a great number of possibilities to analyze the measurement data and decide if a suspicious measurement should not be used for locations calculations.

The first example is referenced to as a ‘Minimum Confidence Area Gauge’. In this example the size of the confidence area (A_{ConfidenceArea}) is calculated. If the resulting confidence area when calculated with a rejected measurement is smaller than if calculated without any rejected measurements, such measurement is selected for rejection and the location calculations are accomplished without the rejected measurement.

Optionally, the confidence area size can be multiplied by the number of hyperbolas used in the calculation. This can be used to increase the number of remaining hyperbolas in the calculations. This may increase the accuracy of the calculations.

The second example is referenced to as ‘Minimum RD-error Gauge’. This gauge can be calculated such that the distance between a location estimate and a reference base transceiver station (BTS), d(EST, BTS_{REF}) is calculated first. Then the distance between the location estimate and other BTS used in the calculation, d(EST, BTS[i]), is calculated. Then it is possible to calculate the gauge

$${RD}_{Gauge} = {\sum }_{i = 1}^{i = {N}_{BTS}} abs [ d ( EST , {BTS}_{REF} ) - d ( EST , BTS [ i ] ) ] ,$$

wherein N_{BTS} is the number of hyperbolas used in the calculation.

It is also optionally possible to normalize the above by calculating

RD′_{Gauge}=RD_{Gauge}/N_{BTS}.

The third example is referenced to as ‘Minimum RD-error times Confidence Area Gauge’. This gauge is a combination of the above two examples and can be calculated as follows:

Times=A_{ConfidenceAera}*RD_{Gauge}.

Any location estimation algorithm capable of providing location estimate and associated confidence area from the set of measurements can be used for the actual location calculations. On aspect of the invention is the process for deciding if the effect of a measurement should be reduced in location calculations.

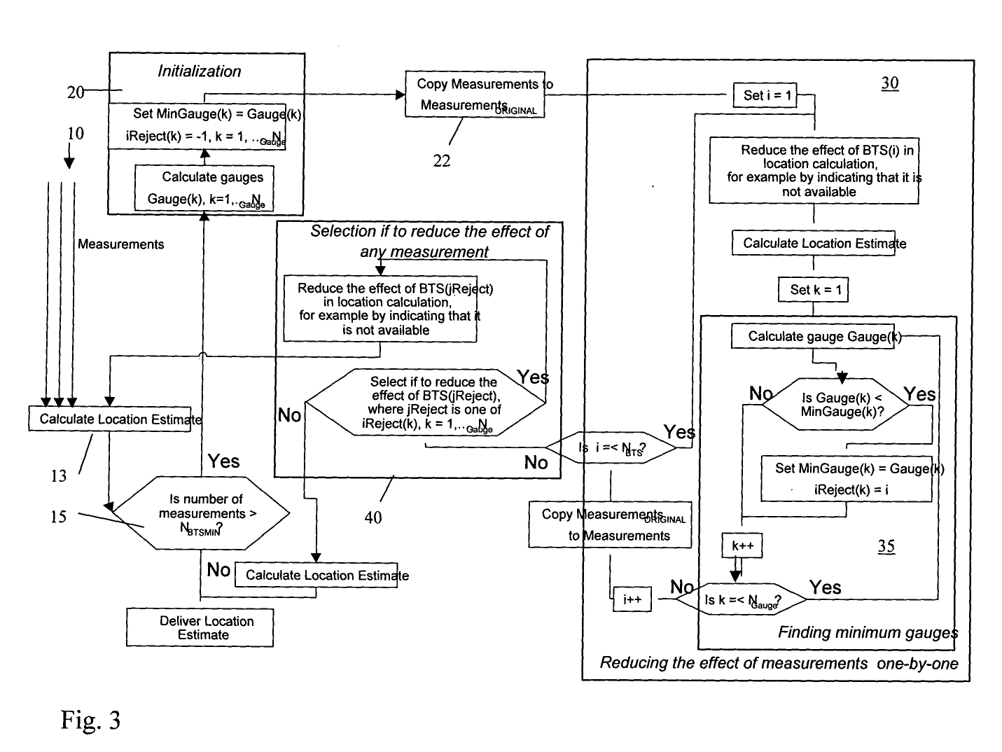

An example of the process for performing such decision making will now be described with reference to FIG. 3.

FIG. 3 is a flowchart for the procedure for minimizing the effect of bad measurements in location calculation in accordance with a preferred embodiment. From the used symbols N_{BTS} refers to the number of measured neighbors, N_{GAUGE} is the number of discrepancy gauges used in process, and N_{BTSMIN} is the minimum number of measurements selected to be used by location calculation. As shown, each of these main steps include various sub-steps.

Measurement data is shown to be input at step 10 into location estimate calculation function 13. At this stage an initial location estimate is produced. The initial estimate takes all measurement data into account. Additional data such as cell ids and so on may also be used for the location estimate calculations.

The initial estimate is then passed to decision block 15. If the number of available measurements is greater than a predetermined threshold for a minimum number of locations measurements required, the processing is forwarded to a so called initialization block 20. If the number of available locations measurements is too low to be reduced, the locations estimate is delivered without any analysis or rejection steps.

In the initialization block 20 initial gauges are calculated for a situation wherein all available measurements are used in location calculations. The initial values for the gauges may be based on a current estimate for the minimum value. The initial values may indicate that the effect of bad measurements has not been reduced.

It may be advantageous to use a copy of the measurement data in the analysis and rejection operations rather that reject any part of the original data. Thus block 22 is shown.

The effect of bad measurements is analyzed by reducing the effect of the measurement one-by-one in block 30. In other words, each measurement may be ignored in its turn and the resulting location estimate is then analyzed. Unless the measurements have been performed in ideal conditions, the rejection of measurements should have effect on the gauge values. The values of the gauges are thus recalculated in block 35 for each reduced set of measurements. If a gauge gets a smaller value than the current estimate for the minimum gauge value, the smaller value can be set to be the current minimum value. A measurement that is rejected so as to reduce the gauge value by the largest amount is marked as a candidate for rejection.

The actual selection if the effect of a measurement should be reduced is made in decision block 40. The selection if the effect of a measurement to the location calculation is to be minimized can be done in various ways. For example, the decision can be based on how many discrepancy gauges indicate that the effect of a base station should be reduced.

Location estimate may then be calculated by using measurements that have not been rejected. It is also possible to start the loop again by passing the data back to block 13.

The proposed embodiment has been tested, for example, on E-OTD location method, and has been found to reduce the location error. In the test cases for E-OTD, the decision to minimize the effect of measurement has been made if at least “Minimum RD-error” and “Minimum RD-error times Confidence Area” gauges were indicating to same BTS. For the case of E-OTD location method, the proposed method for identification and elimination of bad measurements was tested with roughly 3000 samples. The samples were analyzed and it was found that the location accuracy was improved in case of 67% limit by 10% and in case of 95% limit by more than 30%. Thus the method according to the invention significantly improves the accuracy of the cellular location methods.

FIG. 4 illustrates a method of providing location information to a user in a communication system. In Step 400, the invention controls at least one base station. In Step 410, the invention provides a client application with a measurement regarding geographic location information for at least one mobile station. The invention receives the geographic location information for the at least one mobile station in Step 420. The invention transmits, in Step 430, the geographic location information to a location means for providing location services. The invention determines a location estimate, in Step 440, based upon the measurement regarding the geographical information. In Step 450, the invention identifies suspicious measurements by analyzing a discrepancy between the measurement and the location estimate.

It should be appreciated that whilst embodiments of the present invention have been described in relation to mobile stations, embodiments of the present invention are applicable to any other suitable type of mobile user equipment.

The embodiment of the present invention has been described in the context of cellular systems. This invention is also applicable to any other wireless communication systems such as wireless local area networks or satellite based communication systems as well as any hybrids thereof. What is important is that more than one measurement is produced for use by the location estimation process.

It is also noted herein that while the above describes exemplifying embodiments of the invention, there are several variations and modifications which may be made to the disclosed solution.

1. A method of providing information regarding a location of a mobile user of a communication system, the method comprising:
performing measurements for provision of input data for a location calculation function;
analyzing the measurements to identify suspicious measurements;
deciding selected measurements for use by the location calculation function; and
calculating a location estimate for a mobile user based on the selected measurements.

2. The method as recited in claim 1, wherein the step of analyzing further comprises analyzing a discrepancy between the selected measurements and the location estimate.

3. A communication system comprising:
a measuring device configured to perform measurements for provision of input data for a location calculation function;
an analyzer configured to analyze the measurements to identify suspicious measurements;
a deciding unit configured to decide selected measurements for use by the location calculation function; and
a calculating device configured to calculate a location estimate for a mobile user based on the selected measurements.

4. The communication system as recited in claim 3, wherein the analyzer analyzes a discrepancy between the selected measurements and the location estimate.

5. A communication system comprising:
measuring means for performing measurements for provision of input data for a location calculation function;
analyzing means for analyzing the measurements to identify suspicious measurements;
deciding means for deciding selected measurements for use by the location calculation function; and
calculating means for calculating a location estimate for a mobile user based on the selected measurements.

6. The communication system as recited in claim 5, wherein the analyzing means is further configured for analyzing a discrepancy between the selected measurements and the location estimate.

7. A location system comprising:
a controller configured to control at least one base stations;
a location service node configured to provide a client application with a measurement regarding geographic location information of at least one mobile station;
an interface configured to receive the measurement regarding the geographic location information of the at least one mobile station and to transmit the measurement regarding the geographic location information to a location device;
the location device configured to determine a location estimate based upon the measurement regarding the geographic location; and
a suspicious measurement identifier configured to identify suspicious measurements by analyzing a discrepancy between the measurement and the location estimate.

8. The location system as recited in claim 7, wherein the location service node provides location services for a plurality of client applications.

9. The location system as recited in claim 7, wherein the interface comprises a gateway mobile location center.

10. The location system as recited in claim 7, wherein the location estimate is based upon a measurement regarding a position of the at least one mobile station relative to the at least one base station.

11. The location system as recited in claim 7, wherein the location device comprises the suspicious measurement identifier.

12. A method for providing location information to a user in a communication system, the method comprising:
controlling at least one base station;
providing a client application with a measurement regarding geographic location information of at least one mobile station;
receiving the measurement of the geographic location information of the at least one mobile station;
transmitting the measurement of the geographic location information to a location means for providing location services;
determining a location estimate based upon the measurement regarding the geographic location; and
identifying suspicious measurements by analyzing a discrepancy between the measurement and the location estimate.

13. The method as recited in claim 12, further comprising a step of providing location services for a plurality of client applications.

14. The method as recited in claim 12, further comprising a step of providing a gateway mobile location center for providing said client application.

15. The method as recited in claim 12, the step of determining further comprising a step of calculating the location estimate based upon a measurement regarding a position of the at least one mobile station relative to the at least one base station.

16. The method as recited in claim 12, further comprising a step of providing a location device for identifying the suspicious measurements.

17. A location system comprising:
controlling means for controlling at least one base stations;
a first providing means for providing a client application with a measurement regarding geographic location information of at least one mobile station;
receiving means for receiving the measurement regarding the geographic location information of the at least one mobile station;
transmitting means for transmitting the measurement regarding the geographic location information to a location means for location services;
determining means for determining a location estimate based upon the measurement regarding the geographic location; and
identifying means for identifying suspicious measurements by analyzing a discrepancy between the measurement and the location estimate.

18. The location system as recited in claim 17, further comprising a providing location services for a plurality of client applications.

19. The location system as recited in claim 17 further comprising a third providing means for providing a gateway mobile location center for providing said client application.

20. The location system as recited in claim 17, wherein the determining means comprises a calculating means for calculating the location estimate based upon a measurement regarding a position of the at least one mobile station relative to the at least one base station.
